(19) United States
(12) Patent Application Publication
(10) Pub. No.: US 2022/0253704 A1
(43) Pub. Date: Aug. 11, 2022

(54) OPTIMIZATION USING LEARNED NEURAL NETWORK OPTIMIZERS

(71) Applicant: Google LLC, Mountain View, CA (US)

(72) Inventors: Ekin Dogus Cubuk, Sunnyvale, CA (US); Luke Shekerjian Metz, Mountain View, CA (US); Samuel Stern Schoenholz, San Francisco, CA (US); Amil A. Merchant, Greer, SC (US)

(21) Appl. No.: 17/665,457

(22) Filed: Feb. 4, 2022

Related U.S. Application Data
(60) Provisional application No. 63/146,380, filed on Feb. 5, 2021.

(51) Int. Cl. G06N 3/08

(52) U.S. Cl. CPC G06N 3/08

(57) ABSTRACT

Methods, systems, and apparatus, including computer programs encoded on computer storage media, for performing optimization using an optimizer neural network. One of the methods includes for each optimizer network parameter, randomly sampling a perturbation value; generating a plurality of sets of candidate values for the optimizer network parameters, for each set of candidate values of the optimizer network parameters: determining a respective loss value representing a performance of the optimizer neural network in updating one or more sets of inner parameters in accordance with the set of candidate of values of the optimizer network parameters; and updating the current values of the optimizer network parameters based on the loss values for the plurality of sets of candidate values of the optimizer network parameters.

### CROSS-REFERENCE TO RELATED APPLICATION

This application claims priority to U.S. Provisional Application No. 63/146,380, filed on Feb. 5, 2021. The disclosure of the prior application is considered part of and is incorporated by reference in the disclosure of this application.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are recurrent neural networks. A recurrent neural network is a neural network that receives an input sequence and generates an output sequence from the input sequence. In particular, a recurrent neural network can use some or all of the internal state of the network from a previous time step in computing an output at a current time step. An example of a recurrent neural network is a long short term (LSTM) neural network that includes one or more LSTM memory blocks. Each LSTM memory block can include one or more cells that each include an input gate, a forget gate, and an output gate that allow the cell to store previous states for the cell, e.g., for use in generating a current activation or to be provided to other components of the LSTM neural network.

### SUMMARY

This specification describes a system implemented as computer programs on one or more computers in one or more locations that optimizes a set of parameters using an optimizer neural network. The parameters that are to be optimized by the optimizer neural network are called “inner parameters” to distinguish from the network parameters of the optimizer neural network. The optimizer neural network is configured, at each of multiple time steps, to process a network input representing the current values of the inner parameters and to generate a network output representing an update to the inner parameters.

This specification also describes a training system that trains the optimizer neural network. At each of multiple of “outer” time steps, the training system can determine an update to the network parameters of the optimizer neural network by optimizing a set of training inner parameters using the optimizer neural network. At each outer time step, the training system can execute multiple “inner” time steps to optimize the training inner parameters. That is, as described above, at each inner time step, the optimizer neural network can process a network input representing the current values of the training inner parameters to generate a network output representing an update to the training inner parameters. The training system can then use the performance of the training inner parameters to update the network parameters of the optimizer neural network.

Particular embodiments of the subject matter described in this specification can be implemented so as to realize one or more of the following advantages.

Using techniques described in this specification, a system can generate inner parameters that minimize a loss function that is highly irregular. For example, the loss function can have many local minima, and can have high-loss barriers between the local minima that cause standard optimization techniques (e.g., gradient descent) to become “stuck” in a local minimum that is not the global minimum. For example, first- or second-order optimization techniques are often unsuited for incurring the significant loss increases required to transition between the local minima.

Some existing techniques require domain experts to hand-craft different optimization functions and parameters for each different use case. The techniques described in this specification can be used in a wide variety of use cases without requiring hand-crafted features. In some implementations described in this specification, a single trained optimization neural network can be used to solve multiple different optimization problems. In some such implementations, the trained optimization neural network can be used to solve an optimization problem for which the optimization neural network was not trained; that is, the optimization neural network can be trained using a first optimization problem and, after training, be applied to one or more different optimization problems without fine-tuning.

Some existing techniques require extremely long training times to train a model to perform optimization, and can require a large number restarts to achieve good performance. Using techniques described in this specification, a system can train an optimization neural network using significantly less time and computational resources. Furthermore, the trained optimization neural network can achieve a significantly higher performance, while being significantly more efficient, than the existing models.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example optimization system.

FIG. 1B shows two examples of loss landscapes.

FIG. 2 is a flow diagram of an example process for performing a training step during the training the trainee neural network.

FIG. 3 is a flow diagram of an example process for performing a training step during the training of the optimizer neural network using evolutionary strategies with meta-loss clipping.

FIG. 4 is a flow diagram of an example process for performing a training step during the training of the optimizer neural network using genetic algorithms.

Like reference numbers and designations in the various drawings indicate like elements.

### DETAILED DESCRIPTION

This specification describes a system implemented as computer programs on one or more computers in one or more locations that uses an optimizer neural network to optimize a set of inner parameters.

In particular, the system trains the optimizer neural network over a set of “outer time steps” while, at each outer time step, performing multiple “inner time steps.” At each inner time step, the system uses the optimizer neural network to optimize one or more corresponding sets of inner parameters. At each outer time step, the system uses the results of the corresponding inner time step optimizations to update the network parameters of the optimizer neural network at an outer time step.

After the final outer time step, the training system can output the final values for the network parameters of the optimizer neural network. The trained optimizer neural network can then be used to optimize new sets of inner parameters at inference time.

In some implementations, the inner parameters represent a chemical system, e.g., a chemical system that includes one or more molecules. The inner parameters can each represent an interaction or relationship between respective molecules in the chemical system. For example, the optimizer neural network can be configured to update the inner parameters to identify a new molecule or chemical reaction that optimizes one or more properties, e.g., stability.

In some other implementations, the inner parameters each represent a current state of a respective particle in a system of particles. For example, the optimizer neural network can be configured to update the positions of the particles in the group of particles to optimize an objective function. That is, each network output generated by the optimizer neural network can represent an update to the relative positions of the particles in the group of particles. As a particular example, the optimizer neural network can be configured to minimize the potential energy of the group of particles.

In some other implementations, the inner parameters are themselves network parameters of an inner neural network. In particular, at each inner time step, the training system can process multiple training examples using the inner neural network, and train the inner neural network by updating the inner parameters according to a performance of the inner neural network on the training examples. That is, at each inner time step, the network input of the optimizer neural network can be generated using i) the current values of the inner parameters of the inner neural network and ii) a measure of the performance of the inner neural network on the training examples.

The inner neural network can be trained to perform any kind of machine learning task, i.e., can be configured to receive any kind of digital data input and to generate any kind of score, classification, or regression output based on the input.

In some cases, the inner neural network is a neural network that is configured to perform an image processing task, i.e., receive an input image and to process the input image to generate a network output for the input image. For example, the task may be image classification and the output generated by the inner neural network for a given image may be scores for each of a set of object categories, with each score representing an estimated likelihood that the image contains an image of an object belonging to the category. As another example, the task can be image embedding generation and the output generated by the inner neural network can be a numeric embedding of the input image. As yet another example, the task can be object detection and the output generated by the inner neural network can identify locations in the input image at which particular types of objects are depicted. As yet another example, the task can be image segmentation and the output generated by the inner neural network can assign each pixel of the input image to a category from a set of categories.

As another example, if the inputs to the inner neural network are Internet resources (e.g., web pages), documents, or portions of documents or features extracted from Internet resources, documents, or portions of documents, the task can be to classify the resource or document, i.e., the output generated by the inner neural network for a given Internet resource, document, or portion of a document may be a score for each of a set of topics, with each score representing an estimated likelihood that the Internet resource, document, or document portion is about the topic.

As another example, if the inputs to the inner neural network are features of an impression context for a particular advertisement, the output generated by the inner neural network may be a score that represents an estimated likelihood that the particular advertisement will be clicked on.

As another example, if the inputs to the inner neural network are features of a personalized recommendation for a user, e.g., features characterizing the context for the recommendation, e.g., features characterizing previous actions taken by the user, the output generated by the inner neural network may be a score for each of a set of content items, with each score representing an estimated likelihood that the user will respond favorably to being recommended the content item.

As another example, if the input to the inner neural network is a sequence of text in one language, the output generated by the inner neural network may be a score for each of a set of pieces of text in another language, with each score representing an estimated likelihood that the piece of text in the other language is a proper translation of the input text into the other language.

As another example, the task may be an audio processing task. For example, if the input to the inner neural network is a sequence representing a spoken utterance, the output generated by the inner neural network may be a score for each of a set of pieces of text, each score representing an estimated likelihood that the piece of text is the correct transcript for the utterance. As another example, the task may be a keyword spotting task where, if the input to the inner neural network is a sequence representing a spoken utterance, the output generated by the inner neural network can indicate whether a particular word or phrase (“hotword”) was spoken in the utterance. As another example, if the input to the inner neural network is a sequence representing a spoken utterance, the output generated by the inner neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

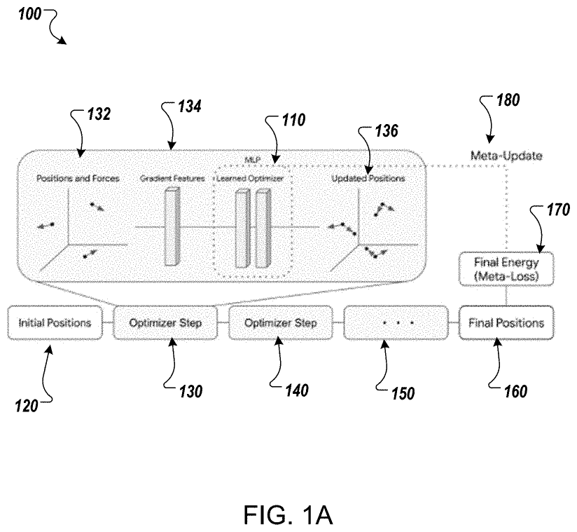

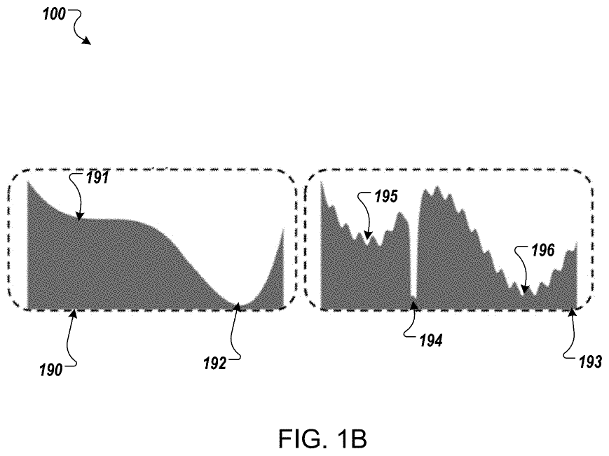

FIG. 1A shows an example optimization system 100. The optimization system 100 is an example of a system implemented as computer programs on one or more computers in one or more locations, in which the systems, components, and techniques described below can be implemented.

The optimization system 100 is a system that performs an inner optimization over multiple inner time steps (“optimizer steps”) 130, 140, and 150 to optimize a set of inner parameters using an optimizer neural network (“learned optimizer”) 110.

In the example of FIG. 1A, the inner optimization is to optimize a set of inner parameters that each represent a current state of a respective particle in a group of particles to optimize an inner objective function that measures the potential energy of the group of particles. Examples of such inner objective functions include the Lennard-Jones Cluster energy measure, the Gupta Cluster energy measure, and the Stillinger-Weber energy measure.

In particular, the inner parameters represent the positions of a set of three particles. While the example of FIG. 1A is simplified for ease of description, the inner parameters can represent more complex measurements of the state of the particles, a system that includes many more than three particles, or both. Additionally, while the example of FIG. 1A shows a system of particles, the inner parameters can represent any of a variety of optimization scenarios, e.g., as described above.

To begin the inner optimization, the system initializes an initial position 120 for each of the particles, e.g., by randomly sampling the positions from a distribution or by setting the positions to pre-defined initial values. In some cases, the system 100 can also randomly sample an inner objective function to optimize, e.g., from a set of multiple different functions that measure the potential energy of the system.

Then, at each inner time step, the system generates an input for the optimizer neural network 110 and processes the input using the optimizer neural network 110 and in accordance with the network parameters of the optimizer neural network 110 to generate an output that defines an update to the inner parameters of the optimizer neural network 110.

In particular, at each inner time step, the system 100 computes a gradient of the inner objective function with respect to the inner parameters and then generates the input to the optimizer neural network by computing features of the gradient.

As a particular example, at the inner time step 130, the system uses the current positions 132 to compute the gradient of the inner objective, i.e., that measures the potential energy of the particle system, and which, as illustrated in FIG. 1A, represents (the negative of) the forces applied to each of the particles.

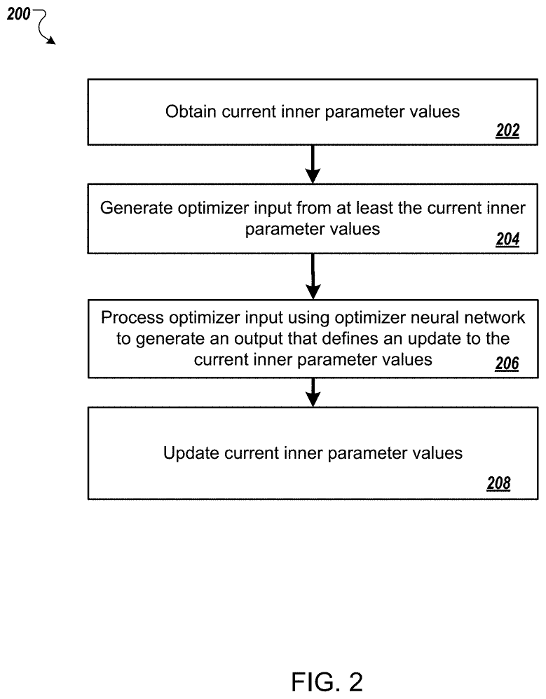

The system 100 then computes gradient features 134 from the computed gradient and the current positions. Computing gradient features is described in more detail below with reference to FIG. 2.

The system 100 generates an input to the optimizer neural network 110 from the gradient features 134 and processes the input using the optimizer neural network 110 in accordance with current values of the network parameters to generate the update to the inner parameters, i.e., to determine updated positions 136 of the particles.

As will be described in more detail below, in some cases the neural network 110 is a multi-layer perceptron (MLP) that operates on the gradient features for each inner parameter independently, i.e., so that the input to the neural network 110 includes a respective sub-input for each inner parameter that is processed independently of the other sub-inputs.

By repeatedly performing this updating over the inner time steps, the system 100 determines final positions 160. A sequence of inner time steps starting from an initial state of the inner parameters, i.e., the inner positions 120, and continuing until a final state of the inner parameters, i.e., the final positions 160 will also be referred to as an inner trajectory.

Generating an inner trajectory is described in more detail below with reference to FIG. 2.

In some cases, the system 100 performs the inner optimization after the optimizer neural network 110 has been trained, i.e., after the optimizer neural network 110 has been trained while generating other inner trajectories for the same inner optimization or different inner optimization(s).

In other cases, the system 100 performs the inner optimization during the training of the optimizer neural network 110. In particular, if the updates generated as a result of the outputs of the neural network 110 are accurate, the final positions 160 will represent inner parameter values that optimize, e.g., minimize in the case of a loss function, the inner objective. Because the updates generated by the optimizer neural network 110 depend on the values of the network parameters, the system 100 trains the optimizer neural network 110 to determine trained values of the network parameters to increase the likelihood that the trajectory will end in inner parameter values that optimize the objective.

In these cases, the system 100 can use the results of the inner trajectory to update the current values of the network parameters of the optimizer neural network 110, i.e., to minimize an outer loss function (“meta-loss”) 170.

Generally, the outer loss function 170 is based on the values of the inner objective for multiple different inner trajectories. That is, the outer loss function 170 measures the performance of the current values of the network parameters in generating the inner trajectories, i.e., as measured by the inner objective values for the inner trajectories.

In the example of FIG. 1A, the outer loss function 170 is based on the value of the inner objective, i.e., the potential energy of the system, when the particles have the final positions 160.

In particular, the system 100 can compute a meta-update 180 based on the values of the inner objective for the inner trajectories and then use meta-update to update the current values of the network parameters of the optimizer neural network 110.

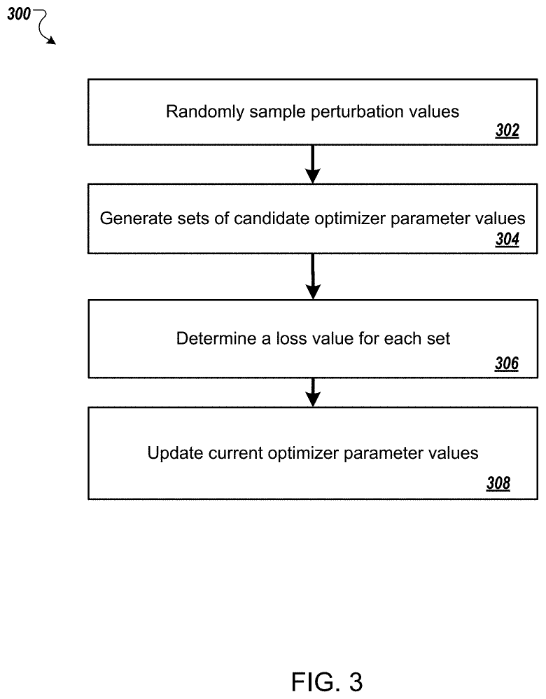

In some implementations, the system 100 updates the network parameters using evolutionary strategies with meta-loss clipping. Training using this technique is described below with reference to FIG. 3.

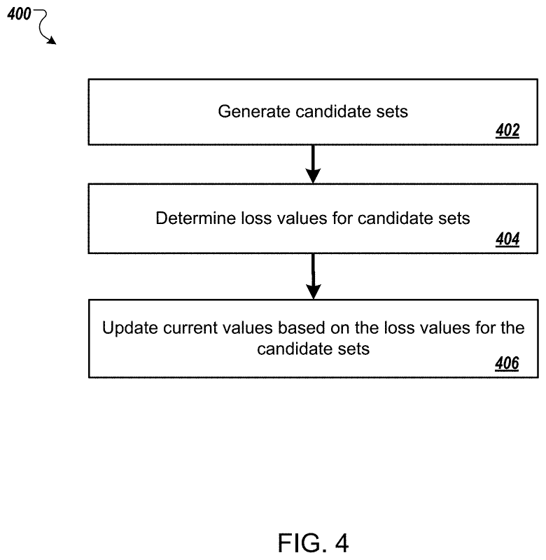

In some other implementations, the system 100 updates the network parameters using genetic algorithms. Training using this technique is described below with reference to FIG. 4.

Training using these two techniques allow the system 100 to train the optimizer neural network 110 even when the inner objective has a very rough landscape.

FIG. 1B shows two examples of loss landscapes.

In particular, FIG. 1B shows a loss landscape 190 that has a surface that is approximately convex, with only a single local minimum 191 and a global minimum 192.

FIG. 1B also shows a loss landscape 193 that has a rough landscape with many unconnected local minima. For example, the local minima 195 and 196 are just two of the many local minima that can be seen on the surface of the loss. The existence of this large number of local minima makes it difficult for conventional techniques for training optimizer neural networks to discover the values of the network parameters that lead to a global minimum 194. For example, conventional techniques may get stuck at one of the local minima 195 and 196 without being to climb the curve to discover the global minimum 194. Training the optimizer neural network using the described techniques, however, can result in high quality performance even when the inner objective has a landscape that is similar to the loss landscape 193 rather than a roughly convex landscape like the landscape 190.

FIG. 2 is a flow diagram of an example process 200 for performing an inner optimization using the optimizer neural network. For convenience, the process 200 will be described as being performed by a system of one or more computers located in one or more locations. For example, an optimization system, e.g., the optimization system 100 of FIG. 1A, appropriately programmed, can perform the process 200.

The system can repeatedly perform the process 200 on different instances of one or more inner optimization tasks to optimize the inner parameters given the instance of the inner optimization task.

The system obtains current values of the optimizer network parameters (step 202). If the process 200 is being performed during training of the optimizer neural network, the current values of the optimizer network parameters are the current values as of the current outer optimization iteration. If the process 200 is being performed after the training of the optimizer neural network, the current values are the trained values of the optimizer network parameters and are the same for all iterations of the process 200.

The system then performs steps 204-208 until a termination criterion is satisfied, e.g., until a threshold number of steps have been performed or until the inner objective values have converged. By performing steps 204-208 until the termination criterion is satisfied, the system generates an inner trajectory.

The system generates an optimizer input (step 204) from at least the current inner parameter values. At the first iteration of step 204, the system can randomly initialize the values of the inner parameter values or set the inner parameter values to fixed values. At subsequent iterations of the step 204, the current inner parameter values are the values after the preceding iteration of the step 204.

To generate the optimizer input when the inner optimization task is training an inner neural network, i.e., the inner parameter values are the parameters of the inner neural network, the system processes a plurality of training examples using the inner neural network in accordance with the inner parameter values to generate respective inner network outputs. The system determines an error of the inner network outputs, e.g., as measured by the inner objective for the training of the inner neural network, and generates the optimizer network input using i) the current values of the inner parameters and ii) the error of the inner network outputs. The inner objective can be any objective function that is appropriate for the task that the inner neural network is configured to perform.

To generate the optimizer input when the inner optimization task is optimizing the positions of particles in a system of particles, i.e., when the inner parameters represent, at least in part, respective states of a plurality of particles, the system determines updated states for the plurality of particles based on the current inner parameter values and generates the optimizer network input using the updated states.

For each inner parameter, the optimizer input includes, e.g., is a concatenation or other combination of, a set of features of the inner parameter that are derived from at least the current value of the inner parameter.

For example, the set of features for a given inner parameter can include the current value of the inner parameter and the gradient of the inner objective with respect to the current value of the inner parameter.

As another example, the set of features can, in addition to the gradient or instead of the gradient, include one or more statistics computed from the gradient and one or more past gradients, e.g., a moving average of the first moment of the gradient, a moving average of the second moment of the gradient, a moment correction, and so on.

The features can also include other features in addition to features that are based on the gradients.

For example, when the inner parameters represent the states of a system of particles, the features can include one or more radial symmetry features that represent a degree of radial symmetry of the plurality of particles.

In particular, a particular radial symmetry feature ϕᵢ corresponding to a particular particle i of the plurality of particles can be determined by computing:

$${ϕ}_{i} = {\sum }_{j \neq i} exp ( η {d}_{ij}^{2} ) θ ( {d}_{ij} ) \\ θ ( {d}_{ij} ) = \{ \begin{matrix}0. if {d}_{ij} > c \\ 0.5 ( cos ( π * {d}_{ij} / c ) + 1 ) otherwise\end{matrix}$$

wherein each particle j is a particle of the plurality of particles that is not the particular particle i, dᵢⱼ is a distance between particle j and the particular particle i, and c and η are hyperparameters.

The system processes the optimizer input using the optimizer neural network to generate an output that defines an update to the current inner parameter values (step 206).

The optimizer neural network can have any appropriate architecture that allows the optimizer neural network to process the optimizer input.

As a particular example, the optimizer neural network can be a feedforward neural network, e.g., a multi-layer perceptron (MLP), that generates the output for each inner parameter independently. That is, the optimizer input can include a respective sub-input for each inner parameter that includes the features for that inner parameter. The optimizer neural network can then process the sub-input for that inner parameter to generate an output that defines the update for that inner parameter.

The optimizer output can define the parameter update for a given inner parameter in any of a variety of ways.

As a particular example, the optimizer output can specify, for each inner parameter (i) a direction value for the parameter update for the inner parameter and (ii) a magnitude value for the parameter update for the inner parameter.

The system can then generate the update by determining an unsigned update from the magnitude, determining a direction from the direction value, and then multiplying the unsigned update by the direction for the inner parameter to generate the update.

As a particular example, the update to the inner parameter can be expressed as:

α·d·sigmoid(β·m·γ)

wherein α, β, and γ are each hyperparameters, d is the direction value, and m is the magnitude value.

The system updates the current inner parameter values (step 208), e.g., by adding or subtracting the update from the current inner parameter values.

If the process 200 is being performed after training, the system can optionally perform additional optimization steps after the last iteration of step 208. In these additional optimization steps, the system can use a conventional optimizer, e.g., a conventional gradient-descent based optimizer, in place of the optimizer neural network to generate the updates to the current inner parameters at each optimization step. Using the conventional optimizer can serve as a fallback if the optimizer using the optimizer neural network failed to find the closest local or global minimum.

FIG. 3 is a flow diagram of an example process 300 for performing a training step during the training of the optimizer neural network using evolutionary strategies with meta-loss clipping. For convenience, the process 300 will be described as being performed by a system of one or more computers located in one or more locations. For example, an optimization system, e.g., the optimization system 100 of FIG. 1A, appropriately programmed, can perform the process 300.

The system can repeatedly perform the process 300 to train the optimizer neural network, i.e., to repeatedly update the values of the optimizer network parameters in order to determine trained values of the optimizer network parameters.

In some implementations, the system performs multiple iterations of the process 300 in parallel, e.g., on different hardware devices, in order to determine multiple gradient estimates with respect to the optimizer network parameters.

The system randomly samples a perturbation value for each of the optimizer network parameters (step 302). In particular, the system samples each perturbation value from a perturbation distribution. Generally, the system can use any appropriate distribution as the perturbation distribution. As a particular example, the system can sample a vector of perturbation values E from a Normal distribution with zero mean, and variance of σ², where σ is a fixed positive value less than one, e.g., 0.05, 0.1, 0.15, or 0.2. That is, the vector ϵ can be generated as: ϵ˜ [symbol] (0, σ²).

The system can generate independent random samples for each iteration of the process 300. For example, each hardware device that is performing the process 300 can independently draw a new sample for each iteration of the process 300 performed by the device.

The system generates multiple sets of candidate values for the optimizer network parameters using the sampled perturbation values (step 304).

In particular, the sets of candidate values include (i) a first set of candidate values for the optimizer network parameters that is equal to the current values of the optimizer network parameters and (ii) one or more additional sets of candidate values for the optimizer network parameters generated by modifying the current values using the sampled perturbation values. As a particular example, the additional sets of candidate values can include (iii) a second set of candidate values for the optimizer network parameters generated by adding each sampled perturbation value to the current value of the corresponding optimizer network parameter; and (iv) a third set of candidate values for the optimizer network parameters generated by subtracting each sampled perturbation value from the current value of the corresponding optimizer network parameter.

The system determines, for each set of candidate values, a respective loss value (step 306).

The respective loss value for a given set of candidate values represents the performance of the optimizer neural network in updating one or more sets of inner parameters in accordance with the set of candidate of values of the optimizer network parameters. That is, the respective loss value measures how well the optimizer neural network performs at performing inner optimization steps when the optimizer network parameters are set to the candidate values.

To determine the respective loss value for a given set of candidate values, the system generates one or more inner optimization trajectories in accordance with the set of candidate values of the optimizer network parameters and computes a respective trajectory loss for each inner optimization trajectory. The system then determines the respective loss value for the given set of candidate values from the respective trajectory losses, e.g., by averaging or adding the respective trajectory losses when there are multiple trajectories or by using the trajectory loss when there is a single trajectory.

Each inner optimization trajectory corresponds to a respective inner optimization task and the system computes a trajectory loss for the trajectory based on the task loss for the inner optimization task.

The system generates a given inner optimization trajectory by performing the process 200 for the corresponding inner optimization task for multiple optimization steps, e.g., for a fixed number of steps, for a fixed amount of time, or until another termination criterion is satisfied.

In some implementations, the system computes the trajectory loss as the average of the inner task losses computed after every optimization step in the trajectory.

In some other implementations, the system computes the trajectory loss as the inner task loss computed after the last optimization step in the trajectory. Computing the trajectory loss using only the inner task loss after the last optimization step can help prioritize global minimum discovery, but may come at the expense of greater variance of the estimated gradients.

The system updates the current values of the optimizer network parameters based on the loss values for the plurality of sets of candidate values of the optimizer network parameters (step 308).

In particular, the system can compute a gradient estimate based on the loss values and then update the current values of the optimizer neural network parameters.

More specifically, when computing the gradient estimate, the system can use the loss value for the first set of candidate values (i.e., that are equal to the current values) to clip the loss value for each additional set of candidate values. Clipping the loss value for an additional set of candidate values refers to constraining the range of the loss value for the additional set of candidate values based on the loss value for the first set of candidate values. For example, the system can set the clipped loss value for the additional set of candidate values equal to the minimum of (i) the loss value for the first set of candidate values and (ii) the loss value for the additional set of candidate values.

That is, for each additional set of candidate values, the system clips the loss value for the additional set of candidate values using the loss value for the first set of candidate values and then generates the gradient estimate using the clipped loss value for each additional set of candidate values.

As a particular example, the gradient estimate can satisfy:

$${∇}_{meta} = [ \frac{min [ L ( θ ) , L ( θ + ϵ ) ] - min [ L ( θ ) , L ( θ - ϵ ) ]}{2 {σ}^{2}} ] ϵ$$

where θ represents the current values of the optimizer network parameters, ϵ represents a vector of the sampled perturbation values, L(θ) is the loss value for the first set of candidate values, L(θ+ϵ) and L(θ−ϵ) are the loss values for respective additional sets of candidate values and σ is a hyperparameter.

Clipping the loss values as described above can improve the stability of the training process of the optimizer neural network. In particular, if the above gradient estimate is computed without clipping, the training becomes vulnerable to optimization difficulties and instability, as either direction of the parameter perturbation may lead to exploding gradients and, therefore, unstable parameter updates. Also, the variance of the estimator makes it more difficult to learn from the sparse rewards when optimizers find better local minima.

By instead clipping the loss values, the system prioritizes the training signal from perturbations that find better minima and improve the overall loss. Additionally, this can bias against directions of high curvature in the training of the optimizer neural network and can therefore improve results. This strategy has the added benefit of heavily clipping the gradients of examples where loss spikes

In implementations where multiple iterations of the process 300 are performed before the current values are updated, e.g., in parallel on multiple devices, the system can average the respective gradient estimates from the multiple iterations to generate an averaged gradient estimate and then apply an optimizer, e.g., Adam, rmsProp, adafactor, stochastic gradient descent, or another optimizer, to the averaged gradient estimate to update the current values of the optimizer network parameters.

FIG. 4 is a flow diagram of an example process 400 for performing a training step during the training of the optimizer neural network using genetic algorithms. For convenience, the process 400 will be described as being performed by a system of one or more computers located in one or more locations. For example, an optimization system, e.g., the optimization system 100 of FIG. 1A, appropriately programmed, can perform the process 400.

The system can repeatedly perform the process 400 to train the optimizer neural network, i.e., to repeatedly update the values of the optimizer network parameters in order to determine trained values of the optimizer network parameters.

The system generates a plurality of candidate sets of candidate values for the optimizer network parameters (step 402). To generate a given candidate set, the system randomly samples a perturbation value for each of the optimizer network parameters and then applies, e.g., adds to or subtracts from, the perturbation values to the current values of the optimizer network parameters. In particular, the system samples each perturbation value from a perturbation distribution. Generally, the system can use any appropriate distribution as the perturbation distribution. As a particular example, the system can sample a vector of perturbation values E from a Normal distribution with zero mean, and variance of σ2, where σ is a fixed positive value less than one, e.g., 0.05, 0.1, 0.15, or 0.2. That is, the vector ϵ can be generated as: ϵ˜ [symbol] (0, σ²).

Thus, because each set of candidate values is generated through random sampling, the sets of candidate values will generally be different from one another.

The system determines, for each set of candidate values, a respective loss value (step 404).

The respective loss value for a given set of candidate values represents the performance of the optimizer neural network in updating one or more sets of inner parameters in accordance with the set of candidate of values of the optimizer network parameters. That is, the respective loss value measures how well the optimizer neural network performs at performing inner optimization steps when the optimizer network parameters are set to the candidate values.

To determine the respective loss value for a given set of candidate values, the system generates one or more inner optimization trajectories in accordance with the set of candidate of values of the optimizer network parameters and computes a respective trajectory loss for each inner optimization trajectory. The system then determines the respective loss value for the given set of candidate values from the respective trajectory losses, e.g., by averaging or adding the respective trajectory losses.

Each inner optimization trajectory corresponds to a respective inner optimization task and the system computes a trajectory loss for the trajectory based on the task loss for the inner optimization task.

The system generates a given trajectory by performing the process 200 for the corresponding inner optimization task for multiple optimization steps, e.g., for a fixed number of steps, for a fixed amount of time, or until another termination criterion is satisfied.

In some implementation, the system computes the trajectory loss as the average of the inner task losses computed after every optimization step in the trajectory.

In some other implementations, the system computes the trajectory loss as the inner task loss computed after the last optimization step in the trajectory. Computing the trajectory loss using only the inner task loss after the last optimization step can help prioritize global minimum discovery, but may come at the expense of greater variance of the estimated gradients.

The system updates the current values of the optimizer network parameters based on the loss values for the plurality of sets of candidate values of the optimizer network parameters (step 406).

In particular, if any of the candidate values have a lower loss value than the loss value for the current values of the optimizer network parameters that was computed at the preceding iteration of the process 400, the system can set the updated current values to be equal to the set of candidate values that has the lowest loss value. If none of the candidates have a lower loss value than the loss value for the current values, the system keeps the values set to the current values, i.e., does not update the current values at the current iteration of the process 400.

Thus, by updating the parameters in this manner, the system only adopts the perturbed parameters when they improve the meta-loss on the current batch of examples, stabilizing the training by decreasing the likelihood that updates that hurt overall performance are adopted.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training an optimizer neural network configured to optimize a plurality of inner parameters by processing an optimizer network input generated from current values of the inner parameters to generate an update to the current values of the inner parameters, wherein the optimizer neural network has a plurality of optimizer network parameters, the method comprising repeatedly performing operations comprising:
identifying current values of the optimizer network parameters;
for each optimizer network parameter, randomly sampling a perturbation value;
generating a plurality of sets of candidate values for the optimizer network parameters, the plurality of sets including:
a first set of candidate values for the optimizer network parameters that is equal to the current values of the optimizer network parameters; and
one or more additional sets of candidate values for the optimizer network parameters generated by modifying the current values using the sampled perturbation values;
for each set of candidate values of the optimizer network parameters:
determining a respective loss value representing a performance of the optimizer neural network in updating one or more sets of inner parameters in accordance with the set of candidate of values of the optimizer network parameters; and
updating the current values of the optimizer network parameters based on the loss values for the plurality of sets of candidate values of the optimizer network parameters.

2. The method of claim 1, wherein the one or more additional sets of candidate values comprise:
a second set of candidate values for the optimizer network parameters generated by adding each sampled perturbation value to the current value of the corresponding optimizer network parameter; and
a third set of candidate values for the optimizer network parameters generated by subtracting each sampled perturbation value from the current value of the corresponding optimizer network parameter.

3. The method of claim 1, wherein updating the current values of the optimizer network parameters comprises:
clipping the loss value for each additional set of candidate values using the loss value for the first set of candidate values; and
generating an update to the current values of the optimizer network parameters using the clipped loss value for each additional set of candidate values.

4. The method of claim 3, wherein generating the update to the current values of the optimizer network parameters comprises computing:
$${∇}_{meta} = [ \frac{min [ L ( θ ) , L ( θ + ϵ ) ] - min [ L ( θ ) , L ( θ - ϵ ) ]}{2 {σ}^{2}} ] ϵ$$
wherein θ represents the current values of the optimizer network parameters, ϵ represents the sampled perturbation values, L(θ) is the loss value for the first set of candidate values, L(θ+ϵ) and L(θ−ϵ) are the loss values for respective additional sets of candidate values and a is a hyperparameter.

5. The method of claim 4, wherein the perturbation values ϵ are sampled from ϵ˜ [symbol] (0, σ²).

6. The method of claim 1, wherein updating the current values of the optimizer network parameters comprises:
updating the current values of the optimizer network parameters to be equal to the set of candidate values that has the lowest corresponding loss value.

7. The method of claim 1, wherein the inner parameters are network parameters of an inner neural network.

8. The method of claim 7, further comprising generating, at each of the plurality of inner time steps, the corresponding optimizer network input, comprising:
processing a plurality of training examples using the inner neural network to generate respective inner network outputs;
determining an error of the inner network outputs; and
generating the optimizer network input using i) the current values of the inner parameters and ii) the error of the inner network outputs.

9. The method of claim 1, wherein the inner parameters represent, at least in part, respective states of a plurality of particles.

10. The method of claim 9, wherein:
obtaining an initial optimizer network input comprises:
determining initial states for the plurality of particles; and
generating the initial optimizer network input using the initial states; and
the method further comprises generating, at each of the plurality of inner time steps, the corresponding optimizer network input, comprising:
determining updated states for the plurality of particles; and
generating the optimizer network input using the updated states.

11. The method of claim 9, wherein each optimizer network input comprises one or more radial symmetry features that represent a degree of radial symmetry of the plurality of particles.

12. The method of claim 11, wherein the one or more radial symmetry features comprises a particular radial symmetry feature ϕᵢ corresponding to a particular particle i of the plurality of particles, and wherein the particular radial symmetry feature ϕᵢ is determined by computing:
$${ϕ}_{i} = {\sum }_{j \neq i} exp ( η {d}_{ij}^{2} ) θ ( {d}_{ij} ) \\ θ ( {d}_{ij} ) = \{ \begin{matrix}0. if {d}_{ij} > c \\ 0.5 ( cos ( π * {d}_{ij} / c ) + 1 ) otherwise\end{matrix}$$
wherein each particle j is a particle of the plurality of particles that is not the particular particle i, dᵢⱼ is a distance between particle j and the particular particle i, and c and η are hyperparameters.

13. The method of claim 9, wherein;
the plurality of inner parameters comprises, for each particle of the plurality of particles, an inner parameter representing a position of the particle; and
the optimizer neural network is configured to generate an optimizer network output comprising, for each particle of the plurality of particles, a direction din which to update the position of the particle and a magnitude m by which to update the position of the particle.

14. The method of claim 13, wherein, for each particle of the plurality of particles, the update to the inner parameter representing the position of the particle is determined by computing:
α·d·sigmoid(β·m·γ)
wherein α, β, and γ are each hyperparameters.

15. The method of claim 14, wherein one or more of α, β, or γ are inner parameters.

16. The method of claim 1, wherein:
the optimizer network input comprises a respective sub-input for each of the plurality of inner parameters; and
updating the current values of the inner parameters comprises, for each inner parameter, processing the respective sub-input using the optimizer neural network to generate the update to the current value of the inner parameter.

17. The method of claim 1, wherein, for each set of candidate values of the optimizer network parameters, determining the loss value representing the performance of the inner parameters comprises:
at each of the plurality of inner time steps, determining a respective time step loss value representing the performance of the inner parameters at the inner time step; and
computing a measure of central tendency of the time step loss values.

18. The method of claim 1, wherein, for each set of candidate values of the optimizer network parameters, determining the loss value representing the performance of the inner parameters comprises:
at each of the plurality of inner time steps, determining a respective time step loss value representing the performance of the inner parameters at the inner time step; and
determining the loss value to be equal to the time step loss value corresponding to the final inner time step of the plurality of inner time steps.

19. A system comprising one or more computers and one or more storage devices storing instructions that when executed by the one or more computers cause the one or more computers to perform operations for training an optimizer neural network configured to optimize a plurality of inner parameters by processing an optimizer network input generated from current values of the inner parameters to generate an update to the current values of the inner parameters, wherein the optimizer neural network has a plurality of optimizer network parameters, the operations comprising:
identifying current values of the optimizer network parameters;
for each optimizer network parameter, randomly sampling a perturbation value;
generating a plurality of sets of candidate values for the optimizer network parameters, the plurality of sets including:
a first set of candidate values for the optimizer network parameters that is equal to the current values of the optimizer network parameters; and
one or more additional sets of candidate values for the optimizer network parameters generated by modifying the current values using the sampled perturbation values;
for each set of candidate values of the optimizer network parameters:
determining a respective loss value representing a performance of the optimizer neural network in updating one or more sets of inner parameters in accordance with the set of candidate of values of the optimizer network parameters; and
updating the current values of the optimizer network parameters based on the loss values for the plurality of sets of candidate values of the optimizer network parameters.

20. One or more non-transitory computer-readable storage media storing instructions that when executed by one or more computers cause the one or more computers to perform operations for training an optimizer neural network configured to optimize a plurality of inner parameters by processing an optimizer network input generated from current values of the inner parameters to generate an update to the current values of the inner parameters, wherein the optimizer neural network has a plurality of optimizer network parameters, the operations comprising:
identifying current values of the optimizer network parameters;
for each optimizer network parameter, randomly sampling a perturbation value;
generating a plurality of sets of candidate values for the optimizer network parameters, the plurality of sets including:
a first set of candidate values for the optimizer network parameters that is equal to the current values of the optimizer network parameters; and
one or more additional sets of candidate values for the optimizer network parameters generated by modifying the current values using the sampled perturbation values;
for each set of candidate values of the optimizer network parameters:
determining a respective loss value representing a performance of the optimizer neural network in updating one or more sets of inner parameters in accordance with the set of candidate of values of the optimizer network parameters; and
updating the current values of the optimizer network parameters based on the loss values for the plurality of sets of candidate values of the optimizer network parameters.
